(19) United States
(12) Patent Application Publication
(10) Pub. No.: US 2025/0186858 A1
(43) Pub. Date: Jun. 12, 2025

(54) REMOTE TRAINING MIRROR SYSTEM

(71) Applicant: Trainer Vue, Inc., Ocala, FL (US)

(72) Inventor: Leanna RUSSO, Ocala, FL (US)

(21) Appl. No.: 18/970,878

(22) Filed: Dec. 5, 2024

Related U.S. Application Data
(60) Provisional application No. 63/607,990, filed on Dec. 8, 2023.

(51) Int. Cl. A63B 71/06; A63B 24/00

(52) U.S. Cl. CPC A63B 71/0622; A63B 24/0003; A63B 24/0075; A63B 2071/0625; A63B 2220/806; A63B 2225/70

(57) ABSTRACT

An integrated, comprehensive software platform and device for inter-communicating across the platform that enables activity trainers to be connected with activity trainees for the purpose of remote training. The software platform enables live and/or recorded video feeds of both the trainer and/or trainee and is compatible with a screen intended for use on an indoor or outdoor activity field. Complementary use of training mirrors adjacent to the field screen, or modified to be incorporated as the field screen, enhance feedback provided by trainers through the software platform and field screen(s), and can function as a field screen under certain circumstances.

### CROSS REFERENCE TO RELATED APPLICATIONS

This application claims the priority of U.S. Provisional Application No. 63/607,990 filed on Dec. 8, 2023, the content of which (text, drawings and claims) is incorporated herein by reference.

### FIELD

The present teachings relate to devices for training athletes and enthusiasts through the use of a training system comprising mirrors, video feed, and live access to remote professional trainers.

### BACKGROUND

The statements in this section merely provide background information related to the present disclosure and may not constitute prior art.

Opportunities for athletes and enthusiasts to train their skills in any sport or activity, such as equestrianism or soccer, or any variety of action related endeavor, are presently limited by geographic and financial concerns. For example, the fields and other open spaces most suitable for practicing such activities are often in rural areas, distant from population centers where enthusiasts, experts, and trainers are more likely located. Furthermore, the cost of hiring a trainer to visit such on-site practice locations can be prohibitive for most athletes and enthusiasts, and certainly for more casual practitioners seeking to enter an endeavor before committing any more resources, financial or otherwise, than necessary to the new hobby, sport, or activity of interest. Nevertheless, it can be vital for such trainers to have real-time visual and auditory contact with trainees in order to provide accurate assessments and critical, effective, and even real-time, feedback.

Thus, there is a need for solutions that enable remote and contemporaneous access to professional trainers in environments that are ideal for skills training.

### SUMMARY

In various embodiments, the present disclosure provides a software platform that enables users to connect with trainers, provide real-time audio and video of their training experience, and receive real-time audio and video training and feedback.

### DRAWINGS

The drawings described herein are for illustration purposes only and are not intended to limit the scope of the present teachings in any way.

FIG. 1 schematically shows the elements or components of a training system.

FIG. 1A is schematic depiction of a user interface for the training software as it might appear to a trainee according to various exemplary embodiments.

FIG. 1B is schematic depiction of a user interface for the training software as it might appear to a trainer according to various exemplary embodiments.

FIG. 1C is schematic depiction of a user interface for the training software as it might appear to an administrator according to various exemplary embodiments.

FIG. 2A is a depiction of an exemplary training system as used by a trainee.

FIG. 2B is a depiction of an exemplary training system comprising complementary mirrors as used by a trainee.

Corresponding reference numerals indicate corresponding parts throughout the several views of drawings.

### DETAILED DESCRIPTION

The following description is merely exemplary in nature and is not intended to limit the present teachings, application, or uses. Throughout this specification, like reference numerals will be used to refer to like elements. Additionally, the embodiments disclosed below are not intended to be exhaustive or to limit the claimed invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the words “exemplary” and “illustrative” mean “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular exemplary embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

Described herein is an equestrian training system comprising a software platform accessible through various trainee devices (including computers, tablets, VR sets, or smartphones) and equipped with one or more cameras that can be integrated or external, connected either wirelessly or via wire. The cameras include motion-tracking capabilities and can be mounted on actuators that allow pivoting, rolling, and rotation to track trainee activities across a larger area. The physical setup includes a field screen (which can serve as the trainee device's display) positioned along the training field's border, complemented by training mirrors that can be installed on either side of the field screen, coplanar with the display. These mirrors allow trainees to observe their own performance while viewing the display content. The system includes three main interfaces: a trainee interface, a trainer interface, and an administrator interface. The trainee interface provides access to features such as lesson scheduling, trainer selection, and account management. The trainer interface allows trainers to manage lessons, view trainee information, and handle payments. The administrator interface provides oversight of the platform's operations, including payment processing, user management, and reporting functions. The system includes audio capabilities through speakers (which can be wireless, Bluetooth, hardwired, or broadcast) and can provide either public or private audio feedback to trainees. The platform includes comprehensive database management for lessons, trainee information, trainer details, and accounting, with all data preferably stored on remote servers or in the cloud. While the system is described in detail below primarily in the context of equestrian training, it is noted that it can be adapted for other training activities.

An equestrian training system comprises a software platform 100 that is accessible using a through a trainee device 110. The trainee device 110 can be any type of computer device, including but not limited to a desktop computer, a laptop computer, a tablet computer, a virtual reality set, or even a cell phone or smart device. The trainee device comprises storage, memory, communication means, input means (e.g. a virtual or physical keyboard or a touch screen), output devices (i.e., speakers and/or a screen). The software can be stored locally on the trainee device 110 or can be accessed remotely, such as by a SAAS. The system also includes a camera 120 which communicates with the trainee device 110 to be controlled by the software. The camera can be integral with the trainee device or external of the trainee device, in which case the communication with the trainee device can be over a wire or wirelessly. The camera works in conjunction with audio communication, including recording, transmitting, and broadcasting audio via wired or wireless speakers.

The system includes motion-tracking capabilities that enable the software platform 100 to identify and follow a variety of trainee activities that occur within sight of the camera. The system can further include an actuator to which the camera 120 is operably connected and which is controlled by the software. The software can control the actuator to pivot, roll, and/or rotate the camera in all dimensions along any axes to alter the camera's field of view and/or to adjust its visible range. Thus, the system can track the trainee's activities across a larger area. The motion tracking capabilities can be incorporated directly into the software or can be commercially available motion tracking software with which the system's software can communicate.

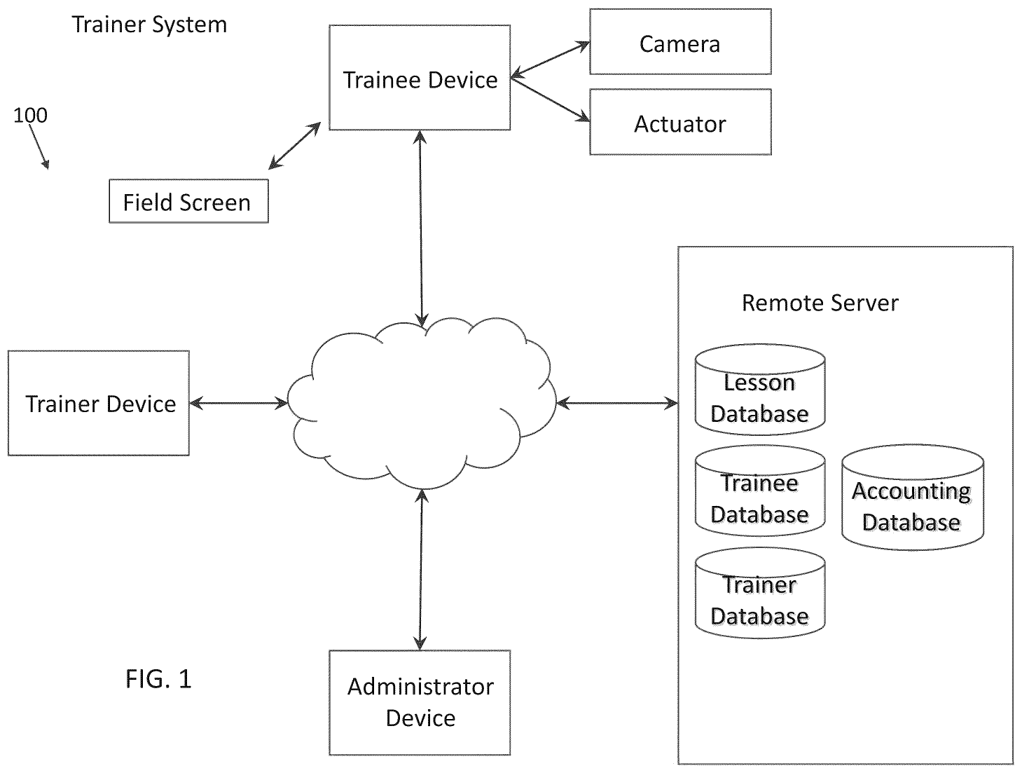

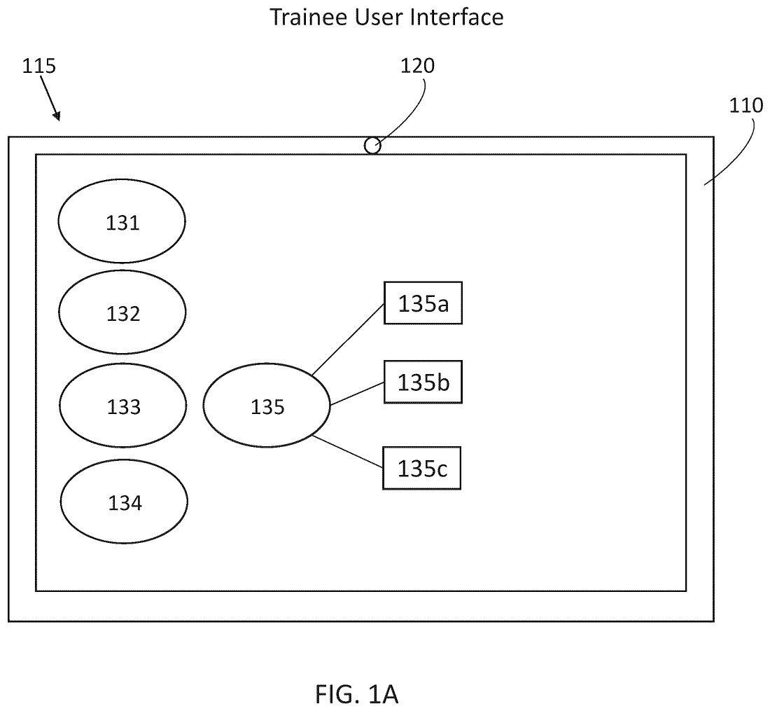

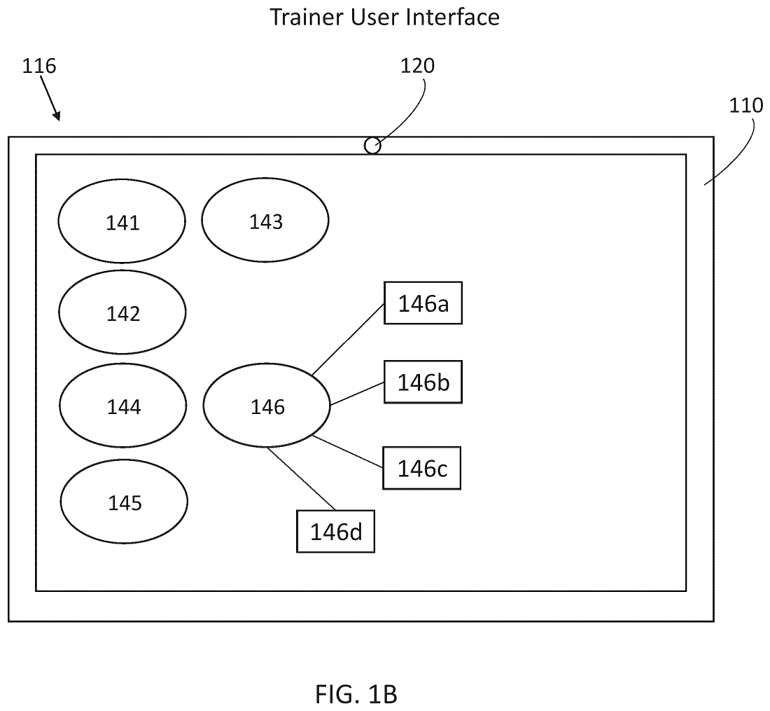

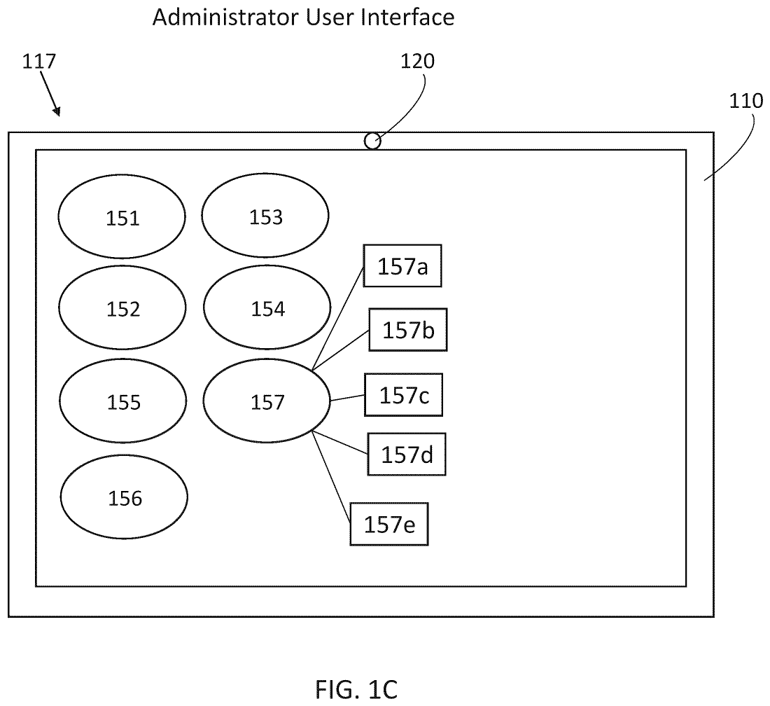

With reference to FIG. 1, the system software is stored, preferably, on a remote server, or in the cloud, which, as described below, is accessed via user devices. The system software includes, among other items, a lesson database (which contains information, including video information, relating to various lessons), a trainee database (which contains information related to trainees), a trainer database (which contains information related to trainers), and an accounting database (which contains accounting information for the trainers and trainees)

Turning to FIG. 1A, the software comprises a trainee interface 115 which enables a trainee using the software platform 100 to access options including but not limited to a sign-up/login menu 131, a calendar 132, a lessons menu 133, a trainer menu 134, and an account menu 135. The sign-up/login menu 131 can contain options enabling a trainee to register an account with the software using one or more details including but not limited to a trainee's name, a trainee's country, a trainee's email, and a trainee's password. The sign-up/login menu 131 can also include an option to log in to an existing account, as well as a routine for recovering a lost or forgotten user password. This information, as can be appreciated, is stored in the trainee database.

The calendar 132 can provide the trainee with a list of past and future lessons as well as the corresponding dates and times for each. Additional features of the calendar 132 include but are not limited to options to enable a trainee to see a lesson description, choose to start a lesson, reschedule or cancel future lessons, leave notes and feedback on past lessons, access recordings of past lessons, and confirm the completion of past lessons from the calendar 132 menu.

The lessons menu 133 enables the trainee to access features including but not limited to a library of recorded video lessons. These lessons are stored in the lessons database on a remote server or in the cloud and are accessible to the trainee using the trainee module's communication capabilities. The lessons menus can include a search functionality that enables the trainee to sort lessons by trainer, upload date, and/or other criteria. The lessons menu can also include a set of lesson notes and/or markups from trainers, the ability to comment on notes and/or markups, and the ability to download lessons for offline review.

The trainer menu 134 accesses the trainer database and enables the trainee to access a listing of trainers. The listing of trainers can be organized according to the trainee's preferences. Additionally, the trainer menu 134 enables the trainee to view trainer profiles, view trainer calendars, schedule and pay for lessons, and edit their rankings of trainers and/or a list of ‘favorited’ trainers.

The account menu 135 accesses the accounting database and enables the trainee to access features including but not limited to a trainee profile 135a, billing information sub-menu 135b, and notifications sub-menu 135c. The trainee profile 135a includes but is not limited to fields such as the trainee's first name, last name, email address, username, password, phone number, country, training activity or activities, and the option to save or update any profile field. The billing information sub-menu 135b includes, without limitation, options for payment listings and billing methods such as credit cards, e-checks, and other payment methods known to one of ordinary skill in the art. The notifications sub-menu 135c includes, without limitation, SMS and email notifications, as well as any other method of notification known to one of ordinary skill in the art, pertaining to, without limitation, pre-lesson reminder notifications, payment receipt notifications, notifications of trainer comments, and software update notifications.

The software platform 100 can also comprise a messaging service that enables the exchange of messages directly between trainees and trainers.

FIG. 1B shows the user interface presented to a trainer when using a trainer device. The trainer device, like the trainee device, can be a computer, a laptop computer, a tablet computer, or even a cell phone. The trainer device comprises storage, memory, communication means, input means (e.g. a virtual or physical keyboard or a touch screen), and output devices (i.e., speakers and/or a screen). A trainer using a trainer device is presented with a trainer interface 116 which provides options, including but not limited to a sign-up/login menu 141, a calendar 142, a lessons menu 143, a trainee menu 144, a trainer menu 145, and an account menu 146. The sign-up/login menu 141 can contain options enabling a trainer to register an account with the software using one or more details including but not limited to a trainer's name, a trainer's chosen training activity, a trainer's classification, comprising for example independent trainers, facility trainers, and company trainers, a trainer's country, a trainer's email, and a trainer's password. The sign-up/login menu 141 can also include an option to log into an existing account, as well as a routine for recovering a lost or forgotten trainer password. This information, as can be appreciated, is stored in the trainer database.

The calendar 142 can provide the trainer with a list of past and future lessons as well as the corresponding dates and times for each. Additional features of the calendar 142 include but are not limited to options to enable a trainer to set a lesson description, choose to start a lesson, reschedule or cancel future lessons, leave notes and feedback on past lessons, access recordings of past lessons, and confirm the completion of past lessons from the calendar 142 menu.

The lessons menu 143 enables the trainer to access features including but not limited to a library of recorded video lessons stored in the lessons database, a search functionality that can sort lessons by trainee, upload date, and/or other criteria, the ability to leave notes and/or markups for trainees, the ability to see comments from trainees, and the ability to download lessons for offline review.

The trainee menu 144 enables the trainer to access features including but not limited to a list of active trainees stored in the trainee database, with which a trainer can access trainee profiles and trainee calendars, and a list of all trainees, which the trainer can search by name, and through which the trainer can access trainee profiles and trainee calendars, and schedule lessons.

The trainer menu 145 enables a facility or company managing one or more trainers to access a listing of trainers stored in the trainer database. The listing of trainers can be organized according to the facility or company's preferences. Additionally, the trainer menu 145 enables the facility or company to view trainer profiles, view trainer calendars, search through trainers by name, mark trainers as either active or inactive, and create new trainer profiles.

The account menu 146 enables the trainer to access features including but not limited to a trainer profile 146a, payments information sub-menu 146b, a lessons settings sub-menu 146c, and notifications sub-menu 146d. The trainer profile 146a includes but is not limited to fields such as the trainer's first name, last name, email address, username, password, phone number, country, training activity or activities, trainer biography, trainer credentials, languages spoken by the trainer, trainer references, trainer website, and the option to save or update any profile field. The payments information sub-menu 146b includes, without limitation, options for payment listings and billing methods such as credit cards, e-checks, and other payment methods known to one of ordinary skill in the art. The lessons settings sub-menu 146c includes, without limitation, options for setting lesson names, classifying lessons as individual or group lessons, setting lesson descriptions and lesson durations, setting lesson prices, providing availability information per lesson, setting lesson cancellation policies, and saving lesson information, as well as editing saved lessons, deleting lessons, and marking lessons as active or inactive. The notifications sub-menu 146d includes, without limitation, SMS and email notifications, as well as any other method of notification known to one of ordinary skill in the art, pertaining to, without limitation, pre-lesson reminder notifications, payment receipt notifications, notifications of trainee comments, and software update notifications.

FIG. 1C shows the interface presented to an administrator using the software platform 100 via an administrator device. The administrator device can be a computer, a laptop computer, a tablet computer, or even a cell phone. The administrator device comprises storage, memory, communication means, input means (e.g. a virtual or physical keyboard or a touch screen), output devices (i.e., speakers and/or a screen). The administrator interface 117 includes options, including but not limited to, a dashboard 151, a payments menu 152, a trainee menu 153, a trainer menu 154, a reviews menu 155, a reports menu 156 and a settings menu 157. The dashboard 151 can, without limitation, contain high-priority key performance indicators related to users of the software platform 100 and overall revenue.

The payments menu 152 can provide the administrator with an organized presentation of data related to lesson payments, organized, according to any means known to one of ordinary skill in the art, including but not limited to a lesson date. The payments menu 152 can also enable the administrator to search payment records by trainee, trainer, lesson date, payment date, and/or information related to a method of payment.

The trainee menu 153 can provide the administrator with information on trainee user accounts, trainee calendars 132, and trainee billing information 135b. Administrator access to trainee billing information 135b can be redacted for security purposes.

The trainer menu 154 can provide the administrator with information on trainers organized, according to any means known to one of ordinary skill in the art, including but not limited to trainer sign-up dates. The administrator can also access trainer user accounts, trainer calendars 142, and trainers payment information 146b. Administrator access to trainer payments information 146b can be redacted for security purposes.

The reviews menu 155 can provide the administrator with trainee reviews of trainers as well as any history of moderation efforts made with regard to a particular trainer.

The reports menu 156 can provide the administrator with reports that the software platform 100 generates. The reports provided in the reports menu 156 can include, by way of example and without limitation, revenue reports, trainer payment reports, trainee statistics reports, and trainee activity reports.

The settings menu 157 can provide the administrator with means to change the settings of the software platform 100. By way of example and without limitation, settings modifiable by the administrator can include changes to a trainer's company name, address, city, state, zip code, and country, a trainer's payment information field, and a trainer's contact information fields. The settings menu 157 can also enable an administrator to make and edit schedules of payments to and from trainers, accepted payment methods and details, supported training activities and fields, supported geographical information for trainees and trainers, and supported coupons, discounts, and other payment incentives and modifications.

The description of the software platform 100 and its various capacities are intended to be non-limiting in nature. Various modifications and alternatives readily apparent to one of ordinary skill in the art are considered to be within the scope of the present disclosure. For example, the trainee device and trainer devices can comprise an integrated battery, a battery charging port, an integrated microphone, mechanical buttons, touchscreen functionality, power-saving circuitry, and other known features. Similarly, the software platform 100 can enable functions not expressly described herein but known in the art, such as aesthetic variations for users and algorithm-based content suggestions for trainees and trainers or integrated cross-marketing or product sales options for goods or materials related to the training session, including but not limited to and by way of example only, user clothing, additional training devices, system accessories or upgrades, or featured deals by partner organizations.

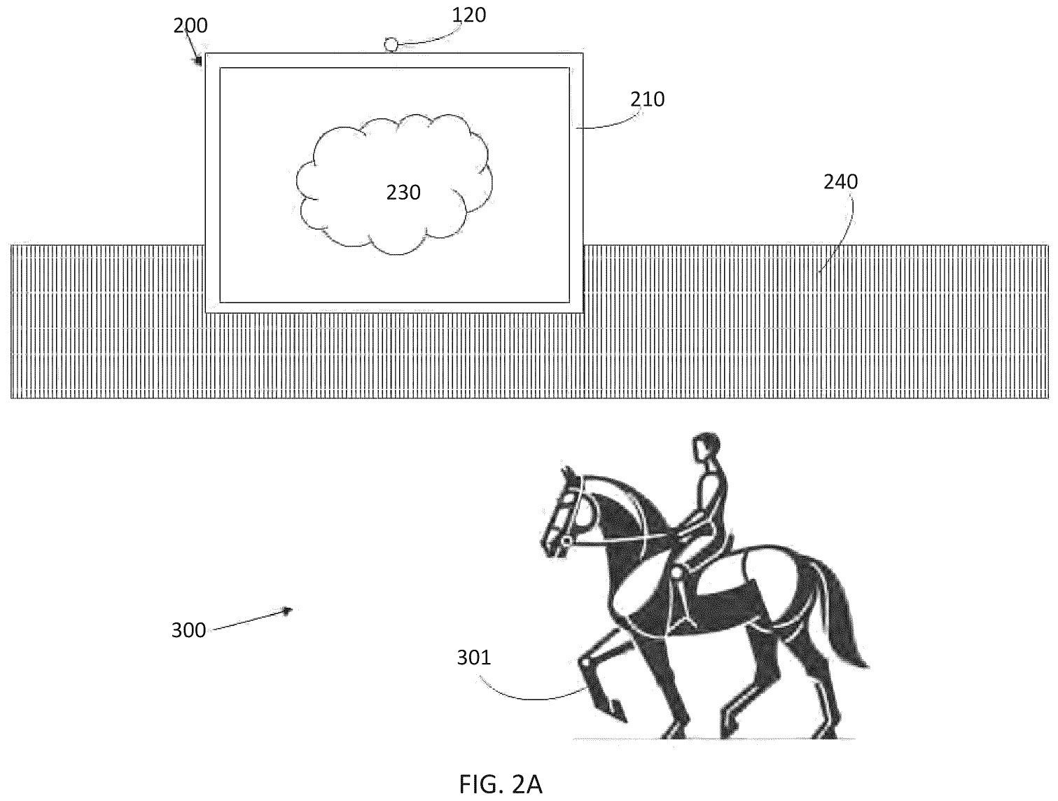

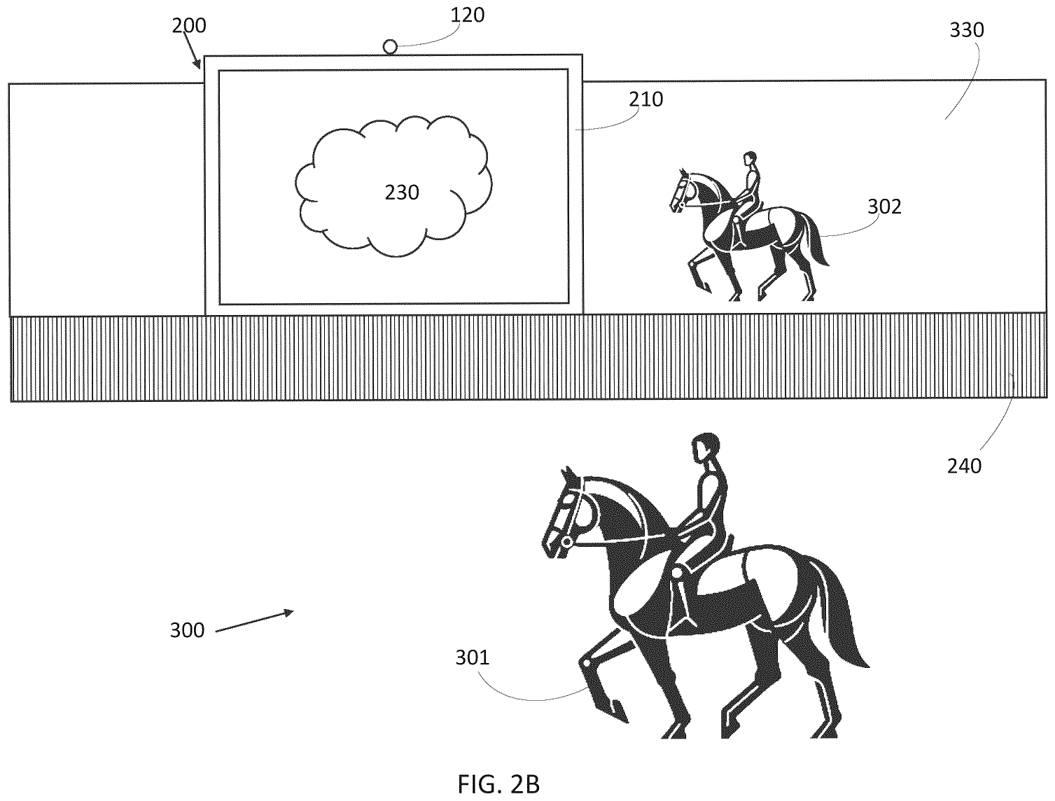

Use of the training platform is shown illustratively in FIG. 2A where a trainee 301 is shown riding a horse in a training field 300 or facility, which can be an indoor or outdoor training field or facility. The training field can include a field screen 200 which can be a display screen for the trainee device or otherwise be in communication with the trainee device.

The training field 300, when used for equestrian training, can be a riding arena for one or more trainees 301. In this situation where the field screen 200 is the display screen of the trainee device, the field screen can comprise the camera, and the camera can be one or more cameras 120 which may be integrated into a field hardware portion 210 and is disposed such that the one or more cameras 120 are capable of viewing a portion or all of the training field 300. Thus, any movements performed by the one or more trainees 301 can be visually identified and tracked by the one or more cameras 120. The field screen 200 can generate a display 230, which can provide an interface as described above for a trainee, and can also provide live or recorded video feed of a training lesson. The field screen 200 can be supplemented by the use of a software platform 100 present on a mobile device in the trainee's possession.

The field screen 200 can be positioned on or against a border 240 of the training field 300, such as a fence, wall, or other barrier. The display 230 of the field screen 200 is sufficiently large and sufficiently bright to be easily observable in an indoor or outdoor environment by the trainee. The brightness of the display 230 can be modulated or enhanced by any means known to one of ordinary skill in the art, including anti-reflective and anti-glare coatings, contrast enhancement, UV-protective materials, polarization layers, optical bonding, strong backlighting, and dynamic adjustment with light sensors.

Turning to FIG. 2B, the field screen 200 can be complemented by one or more training mirrors 330. The one or more training mirrors 330 can provide a reflection 302 of the trainee 301 as they perform training activities on the training field 300. The training mirrors 330 can be sized so as to be comparable in scale to the field screen 200. The one or more training mirrors 330 can be disposed on either side of the field screen 200 such that a reflective surface of each training mirror 330 is coplanar with the display 230 of the field screen.

When multiple field screens 200 are in use, the one or more training mirrors 330 can be disposed between the field screens 200.

Use of the software platform 100 and the field screen 200 for training can proceed as depicted in FIGS. 2A and 2B. A trainee 301 first access the software platform 100 via the trainee device, which can be the field screen 200 or a separate computing device as described above. The trainee accesses the lesson menu and selects a lesson from the lesson database. Once any preliminary requirements have been satisfied, the lesson begins, and any visual lesson content is displayed on or in the display 230. As the lesson proceeds, one or more trainers can observe and track the trainee 301 on their respective trainer devices (or via a single trainer device if multiple trainers are in the same location) via the one or more cameras 120, which enables more accurate and pertinent feedback to and from the one or more trainers. This feedback, in turn, can influence what is shown on the display 230 for the benefit of the trainee 301. Additionally, if one or more training mirrors 330 are installed, the trainee 301 can observe their own performance by viewing their reflection 302 in tandem with the display 230.

Based on what they observe, trainers communicate to trainees, either in real time or as a result of recorded observable data, training feedback. This can be communicated in person, or remotely via audio transmission devices, or speakers, and audio pickup devices, or microphones, situated for this purpose. Data can be stored and saved within a database for later review and to log performance and improvement.

The above description is exemplary in nature and non-limiting, and various additions and variations apparent to one of ordinary skill in the art are considered to be within the scope of the disclosure. For example, although the software platform 100 was described with respect to equestrianism, but this should not be understood as a limiting example, and thus any training activity known to one of ordinary skill in the art is considered within the scope of this disclosure. The field screen 210 can comprise one or more speaker units for providing audio information to the trainee 301. Speakers can be connected wirelessly, through Bluetooth connections or to personal speakers, or can be to hardwired or broadcast speakers. A plurality of trainees 301 may simultaneously benefit from a single training lesson, and either one or a plurality of trainees may benefit from a plurality of field screens 200 installed at a single training field 300. Likewise, the audio information can be provided directly to the trainee through audio a personal audio receiver for private feedback.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A software platform including a trainee device, a field screen, a trainee screen, for connecting activity trainees with activity trainers, comprising:
a trainee interface, comprising options for choosing one or more activity lessons;
a trainer interface, comprising options for generating one or more activity lessons; and,
a function for sending and receiving payments.

2. The software platform of claim 1 further comprising an administrator interface comprising options for managing one or more trainee user accounts and one or more trainer user accounts.

3. The software platform of claim 1 integrated into a device hardware that comprises one or more cameras, further wherein the software platform comprises motion tracking software usable with the one or more cameras.

4. The software platform of claim 1 integrated into a device hardware that comprises one or more speakers, further wherein the software platform comprises motion tracking software usable with one or more cameras.

5. The software platform of claim 3 wherein the one or more cameras enable live video exchange between a trainee and a trainer and recording and storage of video feeds.

6. The software platform of claim 2 further comprising the creation of a plurality of user accounts for one or more trainees, one or more trainers, and one or more administrators.

7. The software platform of claim 6 further comprising one or more calendars for each the plurality of user accounts.

8. The software platform of claim 6 further comprising a messaging service enabling message exchanges between user accounts for trainees and trainers.

9. The software platform of claim 6 further comprising a function for leaving comments on lessons.

10. The software platform of claim 6 further comprising one or more functions for ranking and organizing entries one or more lists of entries comprising user accounts for trainees, user accounts for trainers, and lessons.

11. A field screen comprising a display for displaying the output of a software platform for connecting activity trainees with activity trainers, said field screen comprising one or more cameras, the software platform comprising:
a trainee interface, comprising options for choosing one or more activity lessons;
a trainer interface, comprising options for generating one or more activity lessons; and,
a function for sending and receiving payments;
wherein the field screen is sized and disposed to be visible by a trainee in a training field.

12. The field screen of claim 11 further wherein the one or more cameras include actuators to permit pivoting and rotation of each of the one or more cameras.

13. The field screen of claim 11 integrated with one or more training mirrors.

14. The field screen of claim 11 wherein the display is visible in indoor or outdoor environments and can be modulated to adapt to a variety of ambient lighting conditions.

15. The field screen of claim 13 wherein the one or more training mirrors are sized comparably to the field screen.

16. The field screen of claim 13 wherein the one or more training mirrors are disposed to be on either side of the field screen.

17. The field screen of claim 11 wherein one or more training mirrors are treated or coated to function as indoor/outdoor screens for projectors.

18. The field screen of claim 11 wherein the one or more cameras enable live video exchange between a trainee and a trainer and recording and storage of video feeds through the software platform.

19. A method of training for an activity trainee, comprising:
a. Accessing a software platform for connecting the activity trainee with one or more activity trainers;
b. Integrating the software platform into a hardware device comprising one or more integrated cameras enabling live video feeds; and
c. Scheduling one or more activity training sessions, wherein the activity trainer exchanges live video feed with the one or more activity trainers while performing an activity.

20. The method of claim 19 wherein the one or more activity trainers provide live feedback to the activity trainee through the software platform.

21. The method of claim 19 wherein the software platform enables the recording, storage and retrieval of live video feeds, and further wherein the one or more trainees and activity trainer can exchange messages.

22. The method of claim 19 wherein the hardware device is a field screen integrated into an activity field.
